(19) United States
(12) Patent Application Publication
(10) Pub. No.: US 2024/0060546 A1
(43) Pub. Date: Feb. 22, 2024

(54) BELT WITH BIMODULUS BEHAVIOR DURING OPERATION

(71) Applicant: COMPAGNIE GENERALE DES ETABLISSEMENTS MICHELIN, Clemont-Ferrand (FR)

(72) Inventors: CHRISTOPHE LE CLERC, Clermont-Ferrand (FR); MAGALY BROUSSEAU, Clermont-Ferrand (FR); NATHAN MULLER, Clermont-Ferrand (FR); ERIC MC CORMICK, Clermont-Ferrand (FR)

(21) Appl. No.: 18/271,362

(22) PCT Filed: Dec. 17, 2021
(86) PCT No.: PCT/FR2021/052386

§ 371 Date: Jul. 7, 2023

(30) Foreign Application Priority Data
Jan. 7, 2021 (FR) 2100104

(51) Int. Cl. F16G 5/14; F16G 5/20

(52) U.S. Cl. CPC F16G 5/14; F16G 5/20

(57) ABSTRACT

A power transmission belt (P) comprises one or more reinforcing elements (R) embedded in a polymeric composition (20). For the belt, a ratio of the maximum tangent modulus MP2 in the range from 1 to 10% elongation to the tangent modulus at 1% elongation MP1 MP2/MP1 is greater than or equal to 2.00. The force at 2% elongation over the width of the belt (P) is less than or equal to 120.0 daN/cm. The belt (P) is obtained by embedding one or more reinforcing elements (R) in a polymeric composition (20). For the reinforcing element, a ratio of the maximum tangent modulus MR2 in the range from 1 to 10% elongation to the tangent modulus at 1% elongation MR1 MR2/MR1 is greater than or equal to 2.00. The force at 2% elongation over the diameter of the reinforcing element is strictly less than 11.0 daN/mm.

The field of the present invention is that of power transmission belts and in particular that of those driven by friction.

A power transmission belt comprising a belt ply comprising reinforcing elements comprising an assembly of three 168 tex multifilament strands of aramid known under the trade name Twaron 2100 and of a 94 tex multifilament strand of nylon 6,6 known under the trade name Enka Nylon is known from the prior art, in particular from WO97/06297. The diameter of this reinforcing element is 0.85 mm and the force at 2% elongation developed by the belt ply over the diameter of the reinforcing element is 12.0 daN/mm.

However, it is desirable to have a belt ply that is easy to mount, that is to say exhibits sufficient elongation under a low load in order to be able to be installed on the belt, and when the ply is in operation, it is desirable for it to exhibit good performance in terms of torque transmission with low slip and reduced creep.

The application US20030171181, describing belts with elastic behaviour with a low initial modulus comprising a stack of belt plies at angles, is also known in the prior art. They have the following disadvantages: the belt plies have to be cut, oriented and stacked during their manufacture, and once manufactured the cut reinforcing elements are flush with the edge of the belt, this posing problems of operational durability of the belt.

The aim of the invention is to obtain a belt that is easy to mount while exhibiting good performance in terms of torque transmission in a durable manner.

The subject of the invention is a power transmission belt comprising one or more reinforcing elements embedded in a polymeric composition. The belt is such that:
the ratio of the maximum tangent modulus MP2 in the range from 1 to 10% elongation developed by the belt to the tangent modulus at 1% elongation MP1 developed by the belt MP2/MP1 is greater than or equal to 2.00; and
the force at 2% elongation developed by the belt over the width of the belt is less than or equal to 120.0 daN/cm.

Power transmission belts are understood to be closed or open belts. The belt is used, preferably, with pulleys, and sometimes with a tensioning system such as a tensioner roller or displacement of a pulley. The closed or continuous belt is usable on a pulley system with a substantially fixed size; the open belt (or endless belt) is usable by being cut and adapted to the size of the system and being welded, reattached by the effect of heat and/or the addition of a connector. Flat frictional power transmission belts of rectangular, trapezoidal (“V-belt”), hexagonal or toric section exist; there also exist trapezoidal frictional power transmission belts that are twinned or striated in the lengthwise direction (“ribbed V-belt”), this enormously increasing the contact area between the pulley and the belt; it functions by the teeth gripping the pulley. Frictional power transmission belts that are striated in the transverse direction exist, this limiting the energy dissipated by the bending of the belt (“cogged belt”). The belt may be synchronous. A synchronous belt is a toothed belt that ensures transmission by interlocking and not by grip.

Preferably, power transmission belts are elastic belts, which therefore have a low initial elastic modulus. These belts are easy to mount, sometimes manually. These belts often do not have tensioning systems and are therefore relatively simple to implement. Depending on the lengths of the belts, and the complexity of the tensioning system, it is necessary to extend the elastic belt by 0.5 to 6% and, in the majority of cases, between 1 and 3%. The tension developed by the belt at 2% elongation is representative of the capacity for easily positioning the belt in the groove(s) of the pulleys.

Without being limited to this use, these belts are particularly relevant for drive systems having pulleys positioned at fixed distances.

A reinforcing element is understood to be an element for mechanically reinforcing a matrix in which this reinforcing element is intended to be embedded.

In the present description, unless expressly indicated otherwise, any range of values denoted by the expression “between a and b” represents the range of values from more than “a” to less than “b” (i.e. limits a and b excluded), while any range of values denoted by the expression “from a to b” means the range of values from “a” up to “b” (i.e. including the strict limits a and b).

The compounds mentioned in the description may be of fossil origin or be biobased. In the latter case, they can originate, partially or entirely, from biomass or be obtained from renewable raw materials originating from biomass. In the same way, the compounds mentioned may also originate from the recycling of materials that have already been used, meaning that they may originate, partially or entirely, from a recycling process, or be obtained from raw materials that themselves originate from a recycling process. Strands, filaments, polymers, plasticizers, fillers, etc., are concerned in particular.

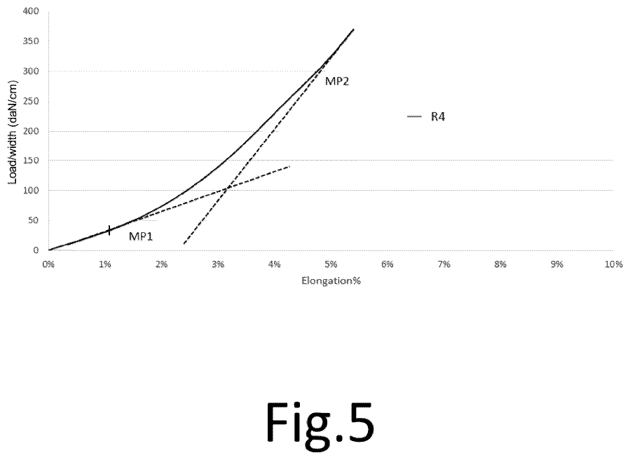

FIG. 5 shows a force/width-elongation curve of a belt according to the invention, with the standard ASTM D 378 of 2016 being applied. The standard is applied with the following modifications: the test machine is equipped with two pulleys with a diameter of 25.4 mm that are adapted to the belts to be tested without the belt sticking in the jaws, the tensile speed used being 50.8 mm/min.

The maximum tangent modulus MP2 in the range from 1 to 10% elongation developed by the reinforcing element is understood to be the maximum tangent modulus that results from calculating the derivative of the force-elongation curve obtained from a force/width-elongation curve obtained by applying the standard ASTM D 378 of 2016 at from 1% to 10% elongation.

The tangent modulus at 1% elongation MP1 developed by the reinforcing element is understood to be the tangent modulus that results from calculating the derivative of the force/width-elongation curve obtained by applying the standard ASTM D 378 of 2016 at 1% elongation.

The force at 2% elongation developed by the belt is understood to be the force measured at 2% that is obtained from a force/width-elongation curve obtained by applying the standard ASTM D 378 of 2016 to the 2% abscissa point of this same curve.

The range according to the invention of the ratio of the maximum tangent modulus MP2 in the range from 1 to 10% elongation developed by the belt to the tangent modulus at 1% elongation MP1 developed by the belt corresponds to the operating domain during the tensioning of the belt that allows the transmission of the driving torque. During the increase in power transmission, slip between the belt and the pulleys causes drops in transmission efficiency. The applicant observed that, with bi-modulus behaviour as defined in this range, there was less slip with the same power transmission. Furthermore, over time, the elastic belts of the prior art tend to creep, i.e. to lengthen plastically in an irreversible manner, making them non-operational. The applicant observed that the creep was greatly limited in the case of marked bi-modulus behaviour in the above-defined range, thereby ensuring greater operational longevity of the belt. Over time, this creep can cause a loss of tension in the elastic belts. This bi-modulus behaviour in the above-defined range, expressed by the ratio MP2/MP1 greater than or equal to 2.0, makes it possible to reduce the creep in the belt ply with high torque transmission.

The force at 2% elongation developed by the belt over the width of the belt is the force necessary for good mountability thereof.

Advantageously, the force at 2% elongation developed by the belt over the width of the belt is less than or equal to 100.0 daN/cm and preferably less than or equal to 80.0 daN/cm.

According to the invention, the power transmission belt is obtained by a method comprising a step of embedding one or more reinforcing elements in a polymeric composition, followed by a curing step to form the belt, wherein the reinforcing element is such that:
the ratio of the maximum tangent modulus MR2 in the range from 1 to 10% elongation developed by the reinforcing element to the tangent modulus at 1% elongation MR1 developed by the reinforcing element MR2/MR1 is greater than or equal to 2.00; and
the force at 2% elongation developed by the reinforcing element over the diameter of the reinforcing element is strictly less than 11.0 daN/mm.

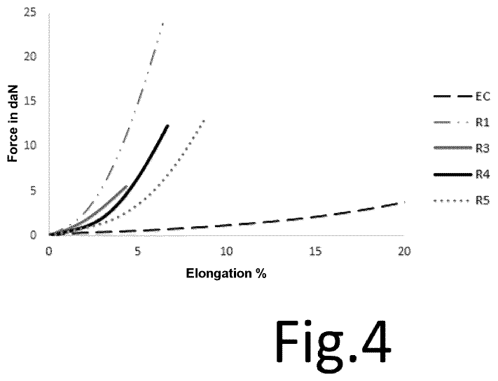

FIG. 4 shows a force-elongation curve of the reinforcing elements of the prior art and of the reinforcing elements according to the invention. This curve is representative of what happens in the belt while it is being mounted when it is loaded little, i.e. subject to small deformations (elongation between 0 and 2%), and when it is subject to the greatest loads during operation, i.e. to elongations between 1 and 10%.

The maximum tangent modulus MR2 in the range from 1 to 10% elongation developed by the reinforcing element is understood to be the maximum tangent modulus that results from calculating the derivative of the force-elongation curve obtained from a force-elongation curve obtained by applying the standard ASTM D 885/D 885M-10a of 2014 at from 1% to 10% elongation after a standard tensile preload of 0.5 cN/tex on the reinforcing element.

The tangent modulus at 1% elongation MR1 developed by the reinforcing element is understood to be the tangent modulus that results from calculating the derivative of the force-elongation curve obtained from a force-elongation curve obtained by applying the standard ASTM D 885/D 885M-10a of 2014 at 1% elongation after a standard tensile preload of 0.5 cN/tex on the reinforcing element.

In the case of the reinforcing element, the tangent modulus is measured directly before the step of embedding the reinforcing element in the belt ply, that is to say without any other step that changes the properties of the tangent modulus having taken place between its final shaping step (twisting or thermal treatment) and the step of embedding in the polymeric composition.

The force at 2% elongation developed by the reinforcing element is understood to be the force measured at 2% obtained from a force-elongation curve obtained under the conditions of the standard ASTM D 885/D 885M-10a of 2014 at the 2% abscissa point of this same curve, which occurs just after a standard tensile preload of 0.5 cN/tex on the reinforcing element.

By definition, the diameter of a reinforcing element is the diameter of the smallest circle inside which the reinforcing element is circumscribed.

The range according to the invention of the ratio of the maximum tangent modulus MR2 in the range from 1 to 10% elongation developed by the reinforcing element to the tangent modulus at 1% elongation MR1 developed by the reinforcing element corresponds to the operating domain during the tensioning of the strand of the belt that allows the transmission of the driving torque. During the increase in power transmission, slip between the belt and the pulleys causes drops in transmission efficiency. The applicant observed that, with bi-modulus behaviour as defined in this range, there was less slip with the same power transmission. Furthermore, over time, the elastic belts of the prior art tend to creep, i.e. to lengthen plastically in an irreversible manner, making them non-operational. The applicant observed that the creep was greatly limited in the case of marked bi-modulus behaviour in the above-defined range, thereby ensuring greater operational longevity of the belt. Over time, this creep can cause a loss of tension in the elastic belts. This bi-modulus behaviour in the above-defined range, expressed by the ratio MR2/MR1 greater than or equal to 2, makes it possible to reduce the creep in the belt ply with high torque transmission.

The force at 2% elongation developed by the reinforcing element over the diameter of the reinforcing element is the force necessary for good mountability of the belt.

Advantageously, the belt comprises a single belt ply made up of a polymeric body 20 comprising a plurality of reinforcing elements. The reinforcing elements are arranged side by side parallel to one another in a longitudinal direction X substantially perpendicular to the general direction Y in which the reinforcing elements of the belt ply extend.

Thus, the manufacture of the belt is made easier a single belt ply and with reinforcers substantially at 0 degrees with two-way elastic behaviour.

Advantageously, each reinforcing element comprises an assembly comprising at least one multifilament strand of aromatic polyamide or aromatic copolyamide, and at least one multifilament strand of aliphatic polyamide or of polyester.

One effect of using a hybrid reinforcing element comprising an assembly of at least one multifilament strand of aromatic polyamide or aromatic copolyamide and of at least one multifilament strand of aliphatic polyamide or of polyester is that a bi-modulus curve is obtained, i.e. one that has a relatively low modulus at small deformations and a relatively high modulus at large deformations. Specifically, the belt ply has a relatively low modulus at small deformations, in this instance controlled by that of the strand of aliphatic polyamide, allowing good mountability. Moreover, the belt reinforcing elements exhibit a relatively high modulus at large deformations, in this instance controlled by that of the strand(s) of aromatic polyamide or aromatic copolyamide, which will make it possible to avoid slip and allow good transmission of the torque under high loading.

Regarding the multifilament strand of aromatic polyamide or aromatic copolyamide, it will be recalled that, as is well known, this is a filament of linear macromolecules formed of aromatic groups held together by amide bonds of which at least 85% are directly connected to two aromatic rings, and more particularly of fibres made of poly(p-phenylene terephthalamide) (or PPTA), which have been being manufactured for a very long time from optically anisotropic spinning compositions. Among aromatic polyamides or aromatic copolyamides, mention may be made of polyarylamides (or PAA, notably known by the Solvay company trade name Ixef), poly(metaxylylene adipamide), polyphthalamides (or PPA, notably known by the Solvay company trade name Amodel), or para-aramids (or poly(paraphenylene terephthalamide or PA PPD-T notably known by the Du Pont de Nemours company trade name Kevlar or the Teijin company trade name Twaron).

A multifilament strand of aliphatic polyamide is understood to be a filament of linear macromolecules of polymers or copolymers containing amide functions that do not have aromatic rings and can be synthesized by polycondensation between a carboxylic acid and an amine. Among the aliphatic polyamides, mention may be made of nylons PA4.6, PA6, PA6.6 or PA6.10, and in particular Zytel from the company DuPont, Technyl from the company Solvay or Rilsamid from the company Arkema.

Regarding the multifilament strand of polyester, it will be recalled that this is a filament of linear macromolecules formed of groups held together by ester bonds. The polyesters are manufactured by polycondensation by esterification between a dicarboxylic acid or one of the derivatives thereof a diol. For example, the polyethylene terephthalate can be manufactured by polycondensation of terephthalic acid and of ethylene glycol. Among known polyesters, mention may be made of polyethylene terephthalate (PET), polyethylene naphthalate (PEN), polybutylene terephthalate (PBT), polybutylene naphthalate (PBN), polypropylene terephthalate (PPT) or polypropylene naphthalate (PPN).

Advantageously, the ratio MR2/MR1 is greater than or equal to 2.50, preferably greater than or equal to 3.00.

Advantageously, the ratio MR2/MR1 is less than or equal to 20.00, preferably less than or equal to 15.00.

Advantageously, the force at 2% elongation developed by the reinforcing element (R) over the diameter of the reinforcing element (R) is less than or equal to 8.0 daN/mm.

Advantageously, the force at 2% elongation developed by the reinforcing element (R) over the diameter of the reinforcing element (R) is greater than or equal to 0.50 daN/mm and preferably greater than or equal to 1.00 daN/mm.

Advantageously, the belt is a frictional power transmission belt.

Advantageously, the diameter of the reinforcing element is less than or equal to 2.00 mm, preferably less than or equal to 1.00 mm and more preferably less than or equal to 0.50 mm.

In a first embodiment, each reinforcing element comprises an assembly made up of a single multifilament strand of aromatic polyamide or aromatic copolyamide, and of a single multifilament strand of aliphatic polyamide or of polyester, the strands being wound together in a helix about one another.

Advantageously, each carcass reinforcing element is twist-balanced.

The multifilament strand of aromatic polyamide or aromatic copolyamide and the multifilament strand of aliphatic polyamide or of polyester are assembled together and wound in a helix about one another.

In a second embodiment, each reinforcing element comprises an assembly made up of two multifilament strands of aromatic polyamide or aromatic copolyamide, and of a single multifilament strand of aliphatic polyamide or of polyester, the strands being wound together in a helix so as to form a layer.

The expression “assembly made up” is understood to mean that the assembly does not comprise a multifilament strand other than the two multifilament strands of aromatic polyamide or aromatic copolyamide and of aliphatic polyamide.

Advantageously, each carcass reinforcing element is twist-balanced.

The following features apply to the two above-described embodiments.

The expression “assembly made up” is understood to mean that the assembly does not comprise a multifilament strand other than the two multifilament strands of aromatic polyamide or aromatic copolyamide or of polyester.

The expression “twist-balanced”, in the two embodiments of the invention, is understood as meaning that the multifilament strands are wound with a substantially identical twist and that the twist of the monofilaments of each multifilament strand in the final assembly is substantially zero. Specifically, the method for manufacturing these carcass reinforcing elements, which is well known in the prior art, comprises a first step during which each spun yarn of monofilaments (more properly referred to as a “yarn”) is first of all twisted individually on itself (with an initial twist R1, R2′, R3′ with R1′=R2′=R3′) in a given direction D′=D1′=D2′=D3′ (the S or Z direction, respectively, according to recognized terminology denoting the orientation of the turns with respect to the transverse bar of an S or of a Z) to form a strand or overtwist (more properly referred to as a “strand”) in which the monofilaments are deformed into a helix about the axis of the strand. Next, during a second step, the strands are then twisted together with a final twist R4 such that R4=R1′=R2′=R3′ in a direction D4 that is the opposite to the direction D′=D1′=D2′=D3′ (the Z or S direction, respectively) so as to obtain the reinforcing element (more properly referred to as a “cord”). This reinforcing element is then said to be twist-balanced, since the monofilaments of the strands exhibit, in the final reinforcing element, the same residual twist, since R1′=R2′=R3′ and this residual twist is zero or substantially zero since R4=R1′=R2′=R3′ and the direction D′=D1′=D2′=D3′ is opposite to the direction D4. The expression “substantially zero residual twist” is understood to mean that the residual twist is strictly less than 2.5% of the twist R4.

Preferably, the count of the multifilament strand(s) of aromatic polyamide or aromatic copolyamide is greater than or equal to 10 tex and preferably greater than or equal to 20 tex.

Preferably, the count of the multifilament strand(s) of aromatic polyamide or aromatic copolyamide is less than or equal to 100 tex, preferably less than or equal to 80 tex and more preferably less than or equal to 60 tex.

Preferably, the count of the multifilament strand of aliphatic polyamide or of polyester is greater than or equal to 10 tex, preferably greater than or equal to 20 tex.

Preferably, the count of the multifilament strand of aliphatic polyamide or of polyester is less than or equal to 100 tex, preferably less than or equal to 80 tex, and more preferably less than or equal to 60 tex.

The count (or linear density) of each strand is determined in accordance with the standard ASTM D1423. The count is given in tex (weight in grams of 1000 m of product—as a reminder: 0.111 tex is equal to 1 denier).

Advantageously, the twist of each multifilament strand of the reinforcing element ranges from 200 to 700 turns per metre and preferably from 250 to 650 turns per metre.

The twist of the reinforcing element can be measured using any method known to a person skilled in the art, for example in accordance with the standard ASTM D 885/D 885M-10a of 2014.

Advantageously, the density of reinforcing elements in the belt ranges from 96 to 250 reinforcing elements per decimetre of belt, preferably from 140 to 220 reinforcing elements per decimetre of belt.

The density of reinforcing elements in the belt ply is the number of reinforcing elements included in one decimetre of the belt ply in the direction (X) perpendicular to the direction (Y) in which the reinforcing element(s) extend parallel to one another.

In order to efficiently use the reinforcement while allowing the manufacture of the belt ply, the edge-to-edge distance between the reinforcing elements represents typically 10 to 50% of the value of the diameter of the reinforcing element. Taking a typical value of 30% of the diameter, the belt ply has a density of 96 to 250 threads per decimetre for a diameter of the reinforcing element ranging from 0.3 to 0.8 mm, allowing it to be manufactured and to be used in a power transmission belt. A person skilled in the art could set this value in accordance with the manufacturing constraints (viscosity of the polymeric composition) or the use conditions.

Preferably, the polymeric composition is a polyurethane-type composition.

As is familiar to a person skilled in the art, a polyurethane-type composition consists of a diisocyanate-terminated prepolymer which is hardened with a diamine or a diol, and can be extended with other polymeric diols or diamines. Other additives may optionally be included to confer various properties, including hardening catalysts, plasticizers, antistatic agents, colourants and fillers, this list not being limiting.

Advantageously, the reinforcing elements are arranged alternately with a final Z and S twist in the direction (X) perpendicular to the direction (Y) of the belt.

In a first alternative, the belt has a shape of the continuous type having an external geometry of trapezoidal, trapezoidal with longitudinal or transverse striations or ribs, circular, semicircular, oblong, rectangular type, or a combination of its shapes.

In a second alternative, the belt has a shape of the welded endless type with an external geometry that is rectangular, trapezoidal, trapezoidal with longitudinal or transverse striations or ribs, circular, semicircular, oblong, or a combination of its shapes.

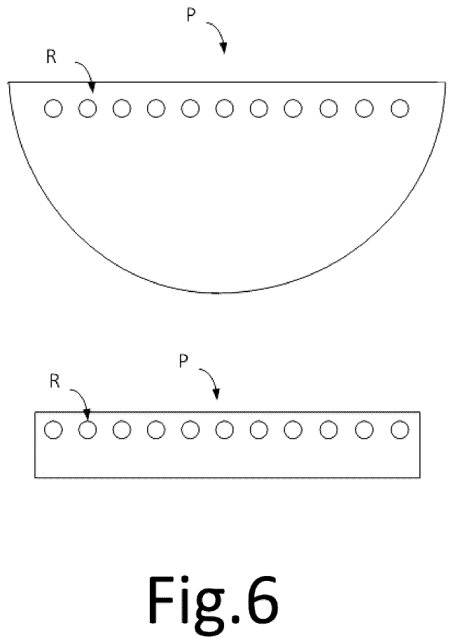

Power transmission belts according to the invention with a semicircular or rectangular shape are notably depicted by way of illustration in FIG. 6.

The invention will be understood better in light of the following description, which is given solely by way of non-limiting example and with reference to the drawings, in which:

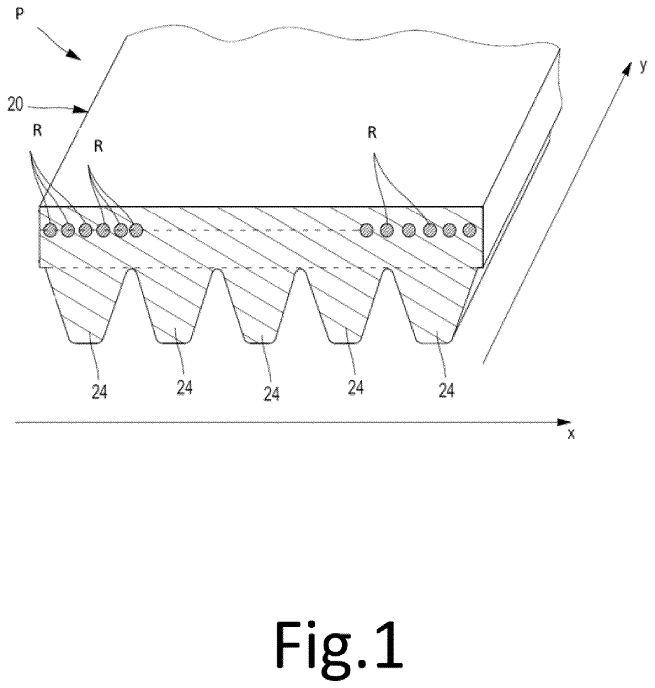

FIG. 1 is a depiction of a power transmission belt P according to the invention;

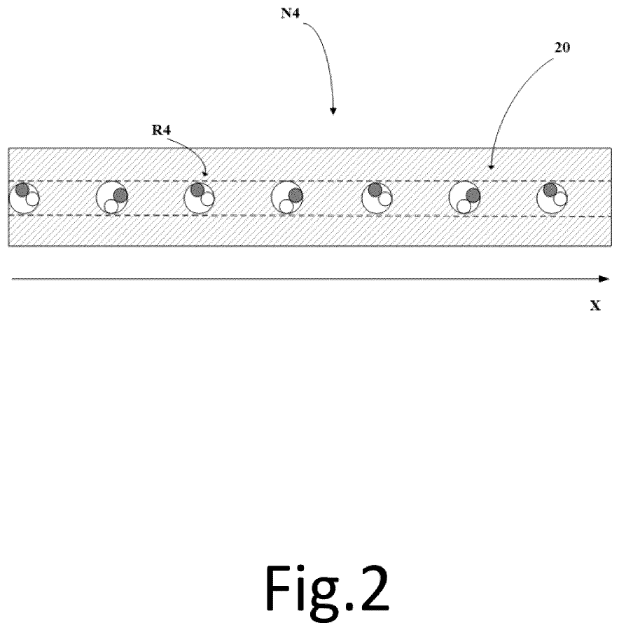

FIG. 2 illustrates the polymeric body 20 from FIG. 1;

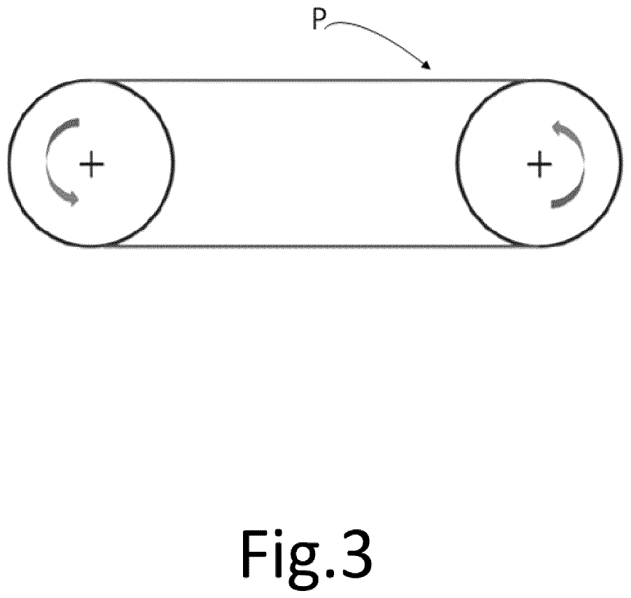

FIG. 3 illustrates a dynamometric test;

FIG. 4 illustrates force-elongation curves of a reinforcing element EC of a belt of the prior art and of the reinforcing elements R1, R3, R4 and R5 of the belts according to the invention;

FIG. 5 illustrates a force-elongation curve of the belt P4 according to the invention; and

FIG. 6 a depiction of other power transmission belts according to the invention.

Example of a Belt P4 According to the Invention

FIG. 1 shows a power transmission belt P according to the invention of the continuous type having an external geometry of the trapezoidal type. The power transmission belt P is intended for driving any member in rotation. The power transmission belt P comprises a polymeric body 20 made from a polyurethane matrix in which reinforcing elements R are embedded so as to form the belt ply. The power transmission belt P also comprises a mechanical drive layer 22, likewise made of polyurethane, in contact with the polymeric body 20. The mechanical drive layer 22 is provided with a plurality of ribs 24 that each extend in a general direction Y substantially perpendicular to a longitudinal direction X of the belt P. Each rib 24 has a trapezoidal shape in cross section. The general directions of the ribs 24 are substantially parallel to one another. The ribs 24 extend along the entire length of the belt P. These ribs 24 are intended to be engaged in grooves or slots of complementary shape, for example carried by pulleys on which the belt is intended to be mounted.

In this case, the belt P is the belt P4 with the reinforcing elements R4.

The polymeric body 20 from FIG. 1 will now be described with reference to FIG. 2. The belt P comprises a single belt ply N4 made up of a polymeric body 20 comprising a plurality of reinforcing elements R4 as illustrated in FIG. 2.

The polymeric body 20 comprises a plurality of reinforcing elements R4. The reinforcing elements are arranged side by side parallel to one another in a longitudinal direction X substantially perpendicular to the general direction Y in which these reinforcing elements of the belt ply extend.

The power transmission belt P4 is such that the ratio of the maximum tangent modulus MP2 in the range from 1 to 10% elongation developed by the belt P4 to the tangent modulus at 1% elongation MP1 developed by the belt P4 MP2/MP1 is greater than or equal to 2.00, in this case, MP2/MP1=3.5, and the force at 2% elongation developed by the belt P4 over the width of the belt P4 is less than or equal to 120.0 daN/cm, preferably less than or equal to 100.0 daN/cm, and even more preferably less than or equal to 80.0 daN/cm, in this case F at 2%=74.7 daN/cm.

A belt reinforcing element R4 and the corresponding assembly will be described below.

Nature of the Strands of the Reinforcing Element

As shown schematically in FIG. 2, the reinforcing element R4 comprises an assembly made up of a multifilament strand of aromatic polyamide or aromatic copolyamide and a multifilament strand of aliphatic polyamide, the two strands being wound together in a helix. The belt reinforcing element P4 is twist-balanced.

The aromatic polyamide chosen is in this case preferably a para-aramid known by the Teijin company trade name Twaron 1000 or Twaron 2040.

The aliphatic polyamide is nylon, known by the Nexis company trade name TYP632 470f68.

Count of the Reinforcing Element R4

In the reinforcing element, the count of the strand of aromatic polyamide or aromatic copolyamide is greater than or equal to 10 tex and preferably greater than or equal to 20 tex, and is less than or equal to 100 tex, preferably less than or equal to 80 tex, and more preferably less than or equal to 60 tex. In this case, the count of the strand of aramid is equal to 55 tex.

In the reinforcing element, the count of the strand of aliphatic polyamide is greater than or equal to 20 tex, preferably greater than or equal to 30 tex, and more preferably greater than or equal to 40 tex, and is less than or equal to 100 tex, preferably less than or equal to 80 tex, and more preferably less than or equal to 60 tex. In this case, the count of the strand of nylon is equal to 47 tex.

Twist of the Reinforcing Element R4

In the reinforcing element R4, the twist of each multifilament strand of the reinforcing element ranges from 240 to 700 turns per metre and preferably from 250 to 650 turns per metre. In this instance, the twist of each multifilament strand of the reinforcing element R4 is equal to 350 turns per metre.

The diameter of the reinforcing element R4 is less than or equal to 2.00 mm, preferably less than or equal to 1.00 mm and more preferably less than or equal to 0.60 mm. In this case, the reinforcing element R4 has a diameter D=0.43 mm.

Force-Elongation Curve of the Reinforcer R4

The ratio of the maximum tangent modulus MR2 in the range from 1 to 10% elongation developed by the reinforcing element R4 to the tangent modulus at 1% elongation MR1 developed by the reinforcing element R4, MR2/MR1, is greater than or equal to 2.00 and preferably greater than or equal to 2.50, and more preferably greater than or equal to 3.00; this ratio MR2/MR1 is less than or equal to 20.00, preferably less than or equal to 15.00. In this case, MR2/M R1=9.3.

The force at 2% elongation developed by the reinforcing element R4 over the diameter of the reinforcing element is strictly less than 11.00 daN/mm and preferably less than or equal to 8.00 daN/mm; this force is greater than or equal to 0.50 daN/mm and preferably greater than or equal to 1.00 daN/mm. In this case, the force at 2% elongation developed by the reinforcing element R4 over the diameter of the reinforcing element is equal to 2.3 daN/mm.

Geometric Features of the Belt Ply N4

The density of the reinforcing element R4 in the belt P4 ranges from 96 to 250 reinforcing elements per decimetre of belt P4, preferably from 140 to 220 reinforcing elements per decimetre of belt P4. In this case, the density of reinforcing elements R4 is equal to 179 reinforcing elements R4 per decimetre of belt P4.

Method for Manufacturing the Reinforcing Element R4

As described above, the reinforcing element R4 is twist-balanced, i.e. the two multifilament strands are wound with a substantially identical twist and the twist of the monofilaments in each multifilament strand is substantially zero. In one embodiment and in a first step, each spun yarn of monofilaments (more properly referred to as a “yarn”) is first of all twisted individually on itself with an initial twist equal to 350 twists per metre in a given direction, in this case the Z direction, to form a strand or overtwist (more properly referred to as a “strand”). Next, during a second step, the two strands are then twisted together with a final twist equal to 350 turns per metre in the S direction so as to obtain the assembly of the reinforcing element (more properly referred to as a “cord”).

In another embodiment and in a first step, each spun yarn of monofilaments is first of all twisted individually on itself with an initial twist equal to 350 turns per metre in a given direction, in this case the S direction, to form a strand or overtwist. Next, during a second step, the two strands are then twisted together with a final twist equal to 350 turns per metre in the Z direction so as to obtain the assembly of the reinforcing element.

Method for Manufacturing the Belt According to the Invention

The method for manufacturing the belt is the one conventionally used by a person skilled in the art.

The belt P4 is manufactured by embedding a plurality of reinforcing elements R4 in a polymeric composition, with interposition of the reinforcing elements assembled in the S and

Z direction as per the above-described embodiments, in a mould. During the embedding step, the reinforcing elements are embedded in a polymeric composition, for example in polyurethane. Finally, the green form thus obtained is crosslinked in order to obtain the belt P4.

Measurements and Comparative Tests

By way of comparative example, two belts of the prior art denoted by the overall reference PEDT and PC, respectively, were taken. Use was also made of three control belts C1, C2 and C3.

The geometric features of the control belts C1, C2 and C3, of the belts of the prior art (PEDT and PC) and of the belts according to the invention P1 to P6 are summarized in Tables 1 and 2 below.

Also indicated in Tables 1 and 2 below is the mountability result of the belts, i.e. the elongation under a low load in order for it to be possible to install them on the pulley.

The term NC means that the measurements were not taken on these various belts.

TABLE 1

| Belt | PEDT | PC | C1 | C2 | C3 |
|---|---|---|---|---|---|
| Reinforcing | EDT | EC | EC1 | EC2 | EC3 |
| element | | | | | |
| Nature of the | Aramid/Aramid/ | Nylon/Nylon/ | Aramid/Aramid/ | Aramid/Aramid/ | PET/PET/PET/ |
| strands | Aramid/Nylon | Nylon | Aramid | Aramid | PET |
| Counts of the | 168/168/168/94 | 23/23/23 | 55/55/55 | 22/22/22 | 23/23/23/23 |
| strands (tex) | | | | | |
| Twists of the | 140/140/140/ | 354/354/ | 350/350/ | 350/350/ | 230/230/ |
| strands | 140/250 | 354/510 | 350/350 | 350/350 | 230/580 |
| (turns/m) | | | | | |
| MR1 in | NC | 0.12 | 4 | 6.2 | NC |
| daN/% | | | | | |
| MR2 in | NC | 0.14 | 14 | 8.4 | NC |
| daN/% | | | | | |
| MR2/MR1 | NC | 1.2 | 3.5 | 1.4 | NC |
| D (mm) | 0.85 | 0.34 | 0.60 | 0.47 | NC |
| F (2%)/D in | 12.0 | 0.8 | 13.9 | 22.6 | NC |
| daN/mm | | | | | |
| Density | NC | 226 | 128 | 164 | NC |
| (ER/dm) | | | | | |
| MP1 in | NC | 379 | NC | 5538 | 1593 |
| daN/% | | | | | |
| MP2 in | NC | 594 | NC | 7077 | 1593 |
| daN/% | | | | | |
| MP2/MP1 | NC | 1.6 | NC | 1.4 | 1 |
| Width P (cm) | NC | 0.70 | NC | 0.7 | 0.70 |
| FP(2%)/DP in | NC | 9.7 | NC | 141.6 | 34.9 |
| daN/cm | | | | | |
| Mountability | yes | Yes | No | no | yes |

TABLE 2

| | | | | | | |
|---|---|---|---|---|---|---|
| Belt | P1 | P2 | P3 | P4 | P5 | P6 |
| Reinforcing | R1 | R2 | R3 | R4 | R5 | R6 |
| element | | | | | | |
| Nature of | Aramid/ | Aramid/ | Aramid/ | Aramid/ | Aramid/ | Aramid/ |
| the strands | Aramid/Nylon | Aramid/Nylon | Nylon | Nylon | Nylon | Nylon |
| Counts of | 55/55/47 | 22/22/47 | 22/47 | 55/47 | 55/47 | 55/47 |
| the strands | | | | | | |
| (tex) | | | | | | |
| Twists of | 350/350/ | 350/350/ | 350/ | 350/ | 500/ | 600/ |
| the strands | 350/350 | 350/350 | 350/350 | 350/350 | 500/500 | 600/600 |
| (turns/m) | | | | | | |
| MR1 in | 1.1 | 1.1 | 0.8 | 0.4 | 0.4 | 0.4 |
| daN/% | | | | | | |
| MR2 in | 6.7 | 3 | 1.8 | 3.7 | 3.3 | 2.7 |
| daN/% | | | | | | |
| MR2/MR1 | 6.1 | 2.7 | 2.3 | 9.3 | 8.3 | 6.8 |
| D (mm) | 0.47 | 0.39 | 0.35 | 0.43 | 0.41 | 0.42 |
| FR (2%)/D | 5.5 | 6.2 | 4.8 | 2.3 | 2.0 | 1.9 |
| in daN/mm | | | | | | |
| Density | 164 | 197 | 220 | 179 | 188 | 183 |
| (ER/dm) | | | | | | |
| MP1 in | NC | NC | NC | 2427 | 998 | NC |
| daN/% | | | | | | |
| MP2 in | NC | NC | NC | 8403 | 6381 | NC |
| daN/% | | | | | | |
| MP2/MP1 | NC | NC | NC | 3.5 | 6.4 | NC |
| Width P | NC | NC | NC | 0.70 | 0.70 | NC |
| (cm) | | | | | | |
| FP(2%)/L in | NC | NC | NC | 74.7 | 31.6 | NC |
| daN/cm | | | | | | |
| Mountability | yes | yes | Yes | yes | yes | yes |

Comparison of the Belts

In order to make a comparative analysis of the belts, dynamometric tests on a machine, as illustrated in FIG. 3, are carried out. The principle of these tests is to drive a belt via two pulleys, one with a driving torque and the other with a braking torque. The torque transmitted is the difference between these two torques and the slip is the difference in rotational speed of these two pulleys. The different tests were carried out at a rotational speed of 1750 rpm.

Three variants of dynamometric tests were carried out:
A first variant during which the pulleys are free to move with respect to one another and the imposed tensile preload PT of 22.7 kg remains fixed during the test. In this case, by imposing a torque of 2.71 N·m for 100 h, it is possible to monitor the variation over time in the position of the pulleys and thus the elongation (in %) of the belt;
A second variant during which the pulleys are at a distance that is kept fixed with an initially imposed tensile preload PT of 22.7 kg. Consequently, by imposing a fixed torque of 2.71 N·m on the belt for 100 hours, it is possible to monitor the decrease in tension in the belt over time compared with the tensile preload PT (in %);
A third variant was finally carried out in the configuration of pulleys free to move with respect to one another. A tensile preload of 22.7 kg was imposed, and a variation in the torque was imposed of between 2.71 N·m and 7.45 N·m. The slip, i.e. the variation in rotational speed between the driving and braking pulleys, was measured. Under conventional operating conditions, the slip is less than 5% and preferably less than 3%.

The results are collated in Table 3 below.

The resistance to the decrease in tension in the belts tested during the test with fixed pulleys is indicated in Table 3. Good resistance to the decrease in tension is indicated by the lowest possible value at a time by measuring the percentage of tension loss between 100 s and 400 000 s. The resistance to creep, i.e. to the elongation during a test with imposed tension and movable pulleys between 10 000 and 400 000 s is also indicated in this table.

In the same way, the maximum admissible torque for obtaining slip less than 5% and 10%, respectively, is indicated, and good transmission of the torque between the driving pulley and braking pulley is indicated by the highest possible value.

TABLE 3

| | | | | |
|---|---|---|---|---|
| Belt | PC | C3 | P4 | P5 |

Creep test

| | | | | |
|---|---|---|---|---|
| Loss of tension | 51 | 31 | 26 | 26 |
| between 100 s | | | | |
| and 400 000 s in | | | | |
| % | | | | |
| Measurement of | 0.45 | 0.25 | 0.15 | 0.15 |
| elongation | | | | |
| between 10 000 | | | | |
| s and 400 000 s | | | | |
| in % | | | | |

Transmission of torque

| | | | | |
|---|---|---|---|---|
| admissible | 2.7 | 4.5 | 5.4 | 5.1 |
| torque to have | | | | |
| slip less than 5% | | | | |
| (N · m) | | | | |
| admissible | 3.1 | 5.2 | 6.4 | 6.0 |
| torque to have | | | | |
| slip less than | | | | |
| 10% (N · m) | | | | |

These results show that the belts P4 and P5 according to the invention exhibit both resistance to the decrease in tension that is greater than the belt of the prior art NC and the control belt C3 and, moreover, a resistance to creep that is significantly better compared with the belt of the prior art NC. The belts P4 and P5 also exhibit a greater capacity to transmit a significant torque for a given level of slip (5% or 10%).

The belts according to the invention therefore exhibit very good resistance to the decrease in tension, an improved resistance to creep and an improved capacity to transmit mechanical torque.

Thus, as the above results show, the invention clearly consists in a power transmission belt comprising one or more reinforcing elements embedded in a polymeric composition. The belt is such that:
the ratio of the maximum tangent modulus MP2 in the range from 1 to 10% elongation developed by the belt to the tangent modulus at 1% elongation MP1 developed by the belt MP2/MP1 is greater than or equal to 2.00; and
the force at 2% elongation developed by the belt (P) over the width of the belt is less than or equal to 120.0 daN/cm.

The invention is not limited to the above-described embodiments.

It may also be possible to combine the features of the different embodiments and variants described or envisaged above, as long as these are compatible with one another and in accordance with the invention.

1.-14. (canceled)

15. A power transmission belt (P) comprising one or more reinforcing elements (R) embedded in a polymeric composition (20),
wherein, for the belt (P), a ratio of a maximum tangent modulus MP2 in a range from 1 to 10% elongation developed by the belt (P) to a tangent modulus at 1% elongation MP1 developed by the belt (P) MP2/MP1 is greater than or equal to 2.00, and
a force at 2% elongation developed by the belt (P) over the width of the belt (P) is less than or equal to 120.0 daN/cm;
wherein the belt (P) is obtained by a method comprising a step of embedding one or more reinforcing elements (R) in a polymeric composition (20), followed by a curing step to form the belt (P); and
wherein, for the one or more reinforcing element (R), a ratio of a maximum tangent modulus MR2 in the range from 1 to 10% elongation developed by the one or more reinforcing elements (R) to a tangent modulus at 1% elongation MR1 developed by the one or more reinforcing elements (R) MR2/MR1 is greater than or equal to 2.00, and
a force at 2% elongation developed by the one or more reinforcing elements (R) over a diameter of the one or more reinforcing elements is strictly less than 11.0 daN/mm.

16. The belt (P) according to claim 15, wherein the force at 2% elongation developed by the belt (P) over the width of the belt (P) is less than or equal to 100.0 daN/cm.

17. The belt (P) according to claim 16, wherein each reinforcing element (R) comprises an assembly comprising at least one multifilament strand of aromatic polyamide or aromatic copolyamide, and at least one multifilament strand of aliphatic polyamide or of polyester.

18. The belt (P) according to claim 15, wherein the ratio MR2/MR1 is greater than or equal to 2.50.

19. The belt (P) according to claim 15, wherein the ratio MR2/MR1 is less than or equal to 20.00.

20. The belt (P) according to claim 15, wherein the force at 2% elongation developed by the reinforcing element (R) over the diameter of the reinforcing element (R) is less than or equal to 8.0 daN/mm.

21. The belt (P) according to claim 15, wherein the force at 2% elongation developed by the reinforcing element (R) over the diameter of the reinforcing element (R) is greater than or equal to 0.50 daN/mm.

22. The belt (P) according to claim 15, wherein the belt (P) is a frictional power transmission belt.

23. The belt (P) according to claim 15, wherein the diameter of the reinforcing element (R) is less than or equal to 2.00 mm.

24. The belt (P) according to claim 15, wherein each reinforcing element (R) comprises an assembly made up of a single multifilament strand of aromatic polyamide or aromatic copolyamide, and of a single multifilament strand of aliphatic polyamide or of polyester, the strands being wound together in a helix about one another.

25. The belt (P) according to claim 15, wherein each reinforcing element (R) comprises an assembly made up of two multifilament strands of aromatic polyamide or aromatic copolyamide, and of a single multifilament strand of aliphatic polyamide or of polyester, the strands being wound together in a helix so as to form a layer.

26. The belt (P) according to claim 15, wherein a density of reinforcing elements (R) in the belt (P) ranges from 96 to 250 reinforcing elements per decimeter of belt (P).

27. The belt (P) according to claim 15, wherein the polymeric composition is a polyurethane-type composition.

28. The belt (P) according to claim 15, wherein the reinforcing elements (R) are arranged alternately with a final Z and S twist in a direction (X) perpendicular to a direction (Y) of the belt (P).
